(19) United States
(12) Patent Application Publication
(10) Pub. No.: US 2012/0011019 A1
(43) Pub. Date: Jan. 12, 2012

(54) COMPUTER IMPLEMENTED AUCTION

(75) Inventor: Buddy Wakim, Roselands (AU)

(73) Assignee: SYDNEY FAMILY SUPERANNUATION FUND PTY LTD, Parramatta, New South Wales (AU)

(21) Appl. No.: 13/256,079

(22) PCT Filed: Mar. 12, 2010
(86) PCT No.: PCT/AU10/00292

§ 371 Date: Sep. 12, 2011

(30) Foreign Application Priority Data
Mar. 12, 2009 (AU) 2009901262
Apr. 2, 2009 (AU) 2009100313
Nov. 9, 2009 (AU) 2009101140
Nov. 9, 2009 (AU) 2009101141

(51) Int. Cl. G06Q 30/00

(52) U.S. Cl. 705/26.3

(57) ABSTRACT

A method, system, processing system, and computer program product for conducting and/or participating in a real-time auction. In one form, the method includes, in a server processing system: receiving, from a seller terminal system, request data indicative of a seller's request to auction an asset; opening a real-time auction via an auction portal hosted by the server processing system for auctioning the asset, wherein the server processing system is able to receive and distribute auction activity data in real-time to and from one or more bidder terminal systems; determining, using the auction activity data, if the auction of the asset has satisfied a close condition of the real-time auction; and closing the real time auction of the asset in response to the close condition being satisfied.

### TECHNICAL FIELD

The present invention generally relates to a method, processing system and/or a computer program product for conducting and participating in a computer implemented auction.

### BACKGROUND

There currently exists a number of computer implemented auction systems. A popular type of computer operated auction system is known as eBay (www.ebay.com.) operated by eBay, Inc. of San Jose, Calif., USA. When a seller wishes to offer a product for auction, the seller completes an online form, wherein the form data is sent to a server processing system in order to display a webpage, near immediately opening the auction for potential bidders to place a bid.

However, this style of auction is generally conducted over a long timeframe (usually a number of days) which has a fixed temporal deadline for the auction to close. This can be disadvantageous as potential bidders may be reluctant to bid until near the deadline for the auction to close. Additionally, this style of auction generally restricts both buyers and sellers being able to enjoy the benefits of a traditional live auction, for example using a bidding strategy.

Therefore, there is a need for a computer operated auction which overcomes or at least alleviates one or more of the above mentioned disadvantages, or at least provides a commercial alternative.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### SUMMARY

In one broad aspect there is provided a method of conducting a real-time auction, wherein the method includes, in a server processing system:

receiving, from a seller terminal system, request data indicative of a seller's request to auction an asset;

opening a real-time auction via an auction portal hosted by the server processing system for auctioning the asset, wherein the server processing system is able to receive and distribute auction activity data in real-time to and from one or more bidder terminal systems;

determining, using the auction activity data, if the auction of the asset has satisfied a close condition of the real-time auction; and

closing the real time auction of the asset in response to the close condition being satisfied.

In one form, the method includes:

receiving, during the auction and from the seller of the asset, seller input data indicative of the seller adjusting a parameter of an acceptable bid for the asset.

In another form, the parameter is a reserve price of the asset, wherein the method includes adjusting in a data store, in response to the seller input data, reserve price data indicative of the reserve price of the asset.

In one embodiment, the method includes adjusting in the data store, in response to the seller input data, the reserve price data associated with the asset to be indicative of a current highest bid received for the asset.

In another embodiment, the method includes:

restricting the seller from adjusting the reserve price until a closing warning is transmitted by the server processing system to one or more bidder terminal systems, wherein upon transmission of the closing warning by the server processing system enables the seller to adjust the reserve price of the asset.

In an optional form, the method includes the server processing system cancelling the closing warning with each of the one or more bidder terminal systems in response to receiving the seller input data.

In another optional form, the method includes determining an opening asking bid for the asset, wherein the opening ask bid is calculated based upon a portion of the reserve price for the asset;

In an optional embodiment, the portion of the reserve price is weighted according to at least one of:

a number of requests to view an advertisement of the asset prior to the opening of the auction; and

a number of enquiries received regarding the asset prior to the opening of the auction.

In another optional embodiment, the method includes, in the server processing system:

receiving, prior to opening the real time auction for the asset, a proxy bid request from one of the bidders;

determining, based upon asset properties of the asset and historical sales data of substantially similar assets, a highest bid value; and

submitting, on behalf of the bidder, one or more bids during the auction of the asset, wherein the one or more bids fail to exceed the highest bid value.

Optionally, the server processing system receives data from the bidder associated with the proxy bid request, wherein the data is indicative of an adjustment to the highest bid value.

In one form, the method includes the server processing system:

receiving a plurality of seller's requests to auction a respective plurality of assets; and

conducting a group of real-time auctions for the plurality of assets, wherein the plurality of real time auctions are conducted in a sequential order.

In another form, the method includes:

determining if a threshold number of seller requests have been received to conduct a group of real time auctions; and

in the event of a successful determination, conducting the group of real time auctions.

In one embodiment, the method includes, in response to receiving one of the seller's requests:

categorising the respective asset associated with one of the seller requests into one of a plurality of groups of real time auctions;

determining if a threshold number of seller requests have been received for the respective group of real time auctions; and

in the event of a successful determination, conducting the group of real time auctions.

In another embodiment, the method includes the server processing system categorising the asset based upon an asset category.

In an optional form, the request data is indicative of the asset category which is defined by the seller at the seller terminal system.

In another optional form, the method includes conducting a plurality of temporally overlapping groups of real-time auctions, wherein the real time auctions for the assets available in each group are conducted in a sequential order.

In another broad aspect there is provided a server processing system for conducting a real time auction, wherein the server processing system is configured to:

receive, from a seller terminal system, request data indicative of a seller's request to auction an asset;

open a real-time auction via an auction portal hosted by the server processing system for auctioning the asset, wherein the server processing system is able to receive and distribute auction activity data in real-time to and from one or more bidder terminal systems;

determine, using the auction activity data, if the auction of the asset has satisfied a close condition of the real-time auction; and

close the real time auction of the asset in response to the close condition being satisfied.

In one form, the server processing system is configured to:

receive, during the auction and from the seller of the asset, seller input data indicative of the seller adjusting a parameter of an acceptable bid for the asset.

In another form, the parameter is a reserve price of the asset, wherein the server processing system is configured to adjust in a data store, in response to the seller input data, reserve price data indicative of the reserve price of the asset.

In one embodiment, the server processing system is configured to adjust in the data store, in response to the seller input data, the reserve price data associated with the asset to be indicative of a current highest bid received for the asset.

In another embodiment, the server processing system is configured to restrict the seller from adjusting the reserve price until a closing warning is transmitted by the server processing system to the one or more bidder terminals, wherein upon transmission of the closing warning by the server processing system, the server processing system enables the seller to adjust the reserve price of the asset.

In an optional form, the server processing system is configured to cancel the closing warning with each of the one or more bidder terminals in response to receiving the seller input data.

In another optional form, the method includes determining an opening asking bid for the asset, wherein the opening ask bid is calculated based upon a portion of the reserve price for the asset;

In an optional embodiment, the portion of the reserve price is weighted according to at least one of:

a number of requests to view an advertisement of the asset prior to the opening of the auction; and

a number of enquiries received regarding the asset prior to the opening of the auction.

In another optional embodiment, the server processing system is configured to:

receive, prior to opening the real time auction for the asset, a proxy bid request from one of the bidders;

determine, based upon asset properties of the asset and historical sales data of substantially similar assets, a highest bid value; and

submit, on behalf of the bidder, one or more bids during the real time auction of the asset, wherein the one or more bids fail to exceed the highest bid value.

Optionally, the server processing is configured to store, in a data store, an adjustment to the highest bid value according to data received from the bidder via the respective bidder terminal system.

In one form, the server processing system is configured to:

receive a plurality of seller's requests to auction a respective plurality of assets; and

conducting a group of real-time auctions for the plurality of assets, wherein the plurality of real time auctions of the group are conducted in a sequential order.

In another form, the server processing system is configured to:

determine if a threshold number of seller requests have been received to conduct a group of real time auctions; and

in the event of a successful determination, conduct the group of real time auctions.

In one embodiment, the server processing system is configured to, in response to receiving one of the seller's requests:

categorise the respective asset associated with one of the seller requests into one of a plurality of groups of real time auctions;

determine if a threshold number of seller requests have been received for the respective group of real time auctions; and

in the event of a successful determination, conduct the respective group of real time auctions.

In another embodiment, the server processing system is configured to categorise the asset based upon an asset category.

In an optional form, the request data is indicative of the asset category which is defined by the seller at the seller terminal system.

In another optional form, the server processing system is configured to conduct a plurality of temporally overlapping groups of real-time auctions, wherein the real time auctions for the assets available in each group are conducted in a sequential order.

In another broad aspect there is provided a computer program product including one or more programs for execution by one or more processors of a server processing system, wherein upon execution of the one or more programs enables the server processing system to conduct a real time auction, the one or more programs includes instructions to configure the server processing system to:

receive, from a seller terminal system, request data indicative of a seller's request to auction an asset;

open a real-time auction via an auction portal hosted by the server processing system for auctioning the asset, wherein the server processing system is able to receive and distribute auction activity data in real-time to and from one or more bidder terminal systems;

determine, using the auction activity data, if the auction of the asset has satisfied a close condition of the real-time auction; and

close the real time auction of the asset in response to the close condition being satisfied.

In one form, the computer, program product configures the server processing system to:

receive, during the auction and from the seller of the asset, seller input data indicative of the seller adjusting a parameter of an acceptable bid for the asset.

In another form, the parameter is a reserve price of the asset, wherein the computer program product configures the server processing system to adjust in a data store, in response to the seller input data, reserve price data indicative of the reserve price of the asset.

In one embodiment, the server processing system is configured to adjust in the data store, in response to the seller input data, the reserve price data associated with the asset to be indicative of a current highest bid received for the asset.

In another embodiment, computer program product configures the server processing system to restrict the seller from adjusting the reserve price until a closing warning is transmitted by the server processing system to the one or more bidder terminals, wherein upon transmission of the closing warning by the server processing system, the server processing system enables the seller to adjust the reserve price of the asset.

In an optional form, the computer program product configures the server processing system to cancel the closing warning with each of the one or more bidder terminals in response to receiving the seller input data.

In another optional form, the computer program product configures the server processing system to determine an opening asking bid for the asset, wherein the opening ask bid is calculated based upon a portion of the reserve price for the asset.

In an optional embodiment, the computer program product configures the server processing system to weight the portion of the reserve price according to at least one of:

a number of requests to view an advertisement of the asset prior to the opening of the auction; and

a number of enquiries received regarding the asset prior to the opening of the auction.

In another optional embodiment, the computer program product configures the server processing system to:

receive, prior to opening the real time auction for the asset, a proxy bid request from one of the bidders;

determine, based upon asset properties of the asset and historical sales data of substantially similar assets, a highest bid value; and

submit, on behalf of the bidder, one or more bids during the real time auction of the asset, wherein the one or more bids fail to exceed the highest bid value.

Optionally, the computer program product configures the server processing system to store, in a data store, an adjustment to the highest bid value according to data received from the bidder via the respective bidder terminal system.

In one form, the computer program product configures the server processing system to:

receive a plurality of seller's requests to auction a respective plurality of assets; and

conducting a group of real-time auctions for the plurality of assets, wherein the plurality of real time auctions of the group are conducted in a sequential order.

In another form, the computer program product is configured to:

determine if a threshold number of seller requests have been received to conduct a group of real time auctions; and

in the event of a successful determination, conduct the group of real time auctions.

In one embodiment, the computer program product configures the server processing system to, in response to receiving one of the seller's requests:

categorise the respective asset associated with one of the seller requests into one of a plurality of groups of real time auctions;

determine if a threshold number of seller requests have been received for the respective group of real time auctions; and

in the event of a successful determination, conduct the respective group of real time auctions.

In another embodiment, the computer program product configures the server processing system to categorise the asset based upon an asset category.

In an optional form, the request data is indicative of the asset category which is defined by the seller at the seller terminal system.

In another optional form, the computer program product configures the server processing system to conduct a plurality of temporally overlapping groups of real-time auctions, wherein the real time auctions for the assets available in each group are conducted in a sequential order.

In an optional embodiment, the computer program product is provided as a computer readable medium.

In another broad aspect there is provided a method of using a bidder terminal system for participating in a real time auction, wherein the method includes, in the bidder terminal system:

receiving and transferring auction activity data in relation to a real time auction via an auction portal hosted by a server processing system for auctioning an asset; and

receiving, from the server processing system, closing condition data indicative of a close condition of the real time auction being satisfied, wherein the server processing system determines whether the closing condition is satisfied based upon auction activity data.

In one form, the method includes: receiving, from the server processing system, a closing warning for the auction of the asset;

receiving, from the server processing system, a cancellation of the closing warning for the auction of the asset in response to the seller of the asset adjusting, during the auction of the asset, a parameter of an acceptable bid for the asset.

In another form, the method includes, in the bidder terminal system transferring, to the server processing system and prior to opening the real time auction for the asset, a proxy bid request from the respective bidder, wherein the server processing system determine, based upon asset properties of the asset and historical sales data of substantially similar assets, a highest bid value, and submits, on behalf of the bidder, one or more bids during the auction of the asset, wherein the one or more bids fail to exceed the highest bid value.

In one embodiment, the method includes:

receiving, from the server processing system, data indicative of the highest bid value; and

transferring, to the server processing system, data indicative of an adjustment to the highest bid value indicated by the bidder via the bidder terminal.

In another embodiment, the method includes receiving, from the server processing system, auction activity data for a group of real-time auctions being conducted for a respective plurality of assets, wherein the plurality of real time auctions are conducted in a sequential order.

In an optional form, the method includes receiving auction activity data indicative of a plurality of temporally overlapping groups of real-time auctions being conducted, wherein the real time auctions for the assets available in each group are conducted in a sequential order.

In another broad aspect there is provided a bidder terminal system for participating in a real time auction, wherein the bidder terminal system is configured to:

receive and transfer auction activity data in relation to a real time auction via an auction portal hosted by a server processing system for auctioning an asset; and

receive, from the server processing system, closing condition data indicative of a close condition of the real time auction being satisfied, wherein the server processing system determines whether the closing condition is satisfied based upon auction activity data.

In one form, the bidder terminal system is configured to:

receive, from the server processing system, a closing warning for the auction of the asset;

receive, from the server processing system, a cancellation of the closing warning for the auction of the asset in response to the seller of the asset adjusting, during the auction of the asset, a parameter of an acceptable bid for the asset.

In another form, the bidder terminal system is configured to transfer, to the server processing system and prior to opening the real time auction for the asset, a proxy bid request from the respective bidder, wherein the server processing system determine, based upon asset properties of the asset and historical sales data of substantially similar assets, a highest bid value, and submits, on behalf of the bidder, one or more bids during the auction of the asset, wherein the one or more bids fail to exceed the highest bid value.

In one embodiment, the bidder terminal system is configured to:

receive, from the server processing system, data indicative of the highest bid value; and

transfer, to the server processing system, data indicative of an adjustment to the highest bid value indicated by the bidder via the bidder terminal.

In another embodiment, the bidder terminal system is configured to receive, from the server processing system, auction activity data for a group of real-time auctions being conducted for a respective plurality of assets, wherein the plurality of real time auctions are conducted in a sequential order.

In an optional form, the bidder terminal system is configured to receive auction activity data indicative of a plurality of temporally overlapping groups of real-time auctions being conducted, wherein the real time auctions for the assets available in each group are conducted in a sequential order.

In another broad aspect there is provided a method of using a seller terminal system for participating in a real time auction, wherein the method includes, in the seller terminal system operated by a seller of the asset:

receiving auction activity data in relation to a real time auction via an auction portal hosted by a server processing system for auctioning the asset of the seller; and

transferring, during the auction of the asset, seller input data indicative of the seller adjusting a parameter of an acceptable bid for the asset, wherein a closing condition of the auction for the asset is determined by the server processing system according to the adjustment to the parameter of an acceptable bid for the asset.

In one form, the parameter is a reserve price of the asset.

In another form, the method includes adjusting the reserve price data associated with the asset to be indicative of a current highest bid received for the asset during the auction.

In one embodiment, the method includes enabling selection an interface element of a user interface associated with adjusting the reserve price when a closing warning is transmitted by the server processing system to the one or more bidder terminal systems.

Other embodiments will be described throughout the description of the example embodiments.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 illustrates a functional block diagram of an example processing system that can be utilised to embody or give effect to a particular embodiment;

FIG. 2 illustrates a block diagram of an example network of processing system that can be utilised to embody or give effect to a particular embodiment;

FIG. 3 illustrates a flow chart representing an example method of conducting an auction;

FIG. 4 illustrates a more detailed flow chart representing an example method of conducting an auction;

FIG. 5 illustrates an example of a bidding interface to participate in the real time auction system;

FIG. 6 illustrates an example of a bidding interface to participate in multiple real time auctions;

FIG. 7 illustrates an example of a seller's interface to allow the seller view seller assets available during one or more real time auctions;

FIG. 8 illustrates an example of the sellers interface to allow the seller to provide input during one or more real time auctions;

FIG. 9 illustrates an example of a group of real time auctions;

FIG. 10 illustrates an example of a bidding interface illustrating an opening asking bid for the asset;

FIG. 11 illustrates an example of a bidder's interface to find multiple real time auction sessions; and

FIG. 12 illustrates an example of a search interface for identifying one or more sellers which satisfy a search criteria.

### DESCRIPTION OF EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

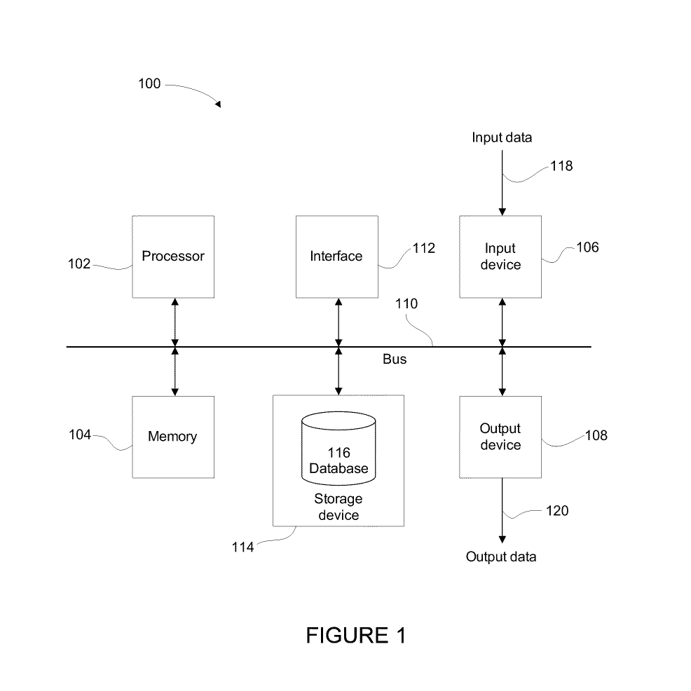

A particular embodiment can be realised using a processing system, an example of which is shown in FIG. 1. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 also can be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116 and/or the memory 104. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

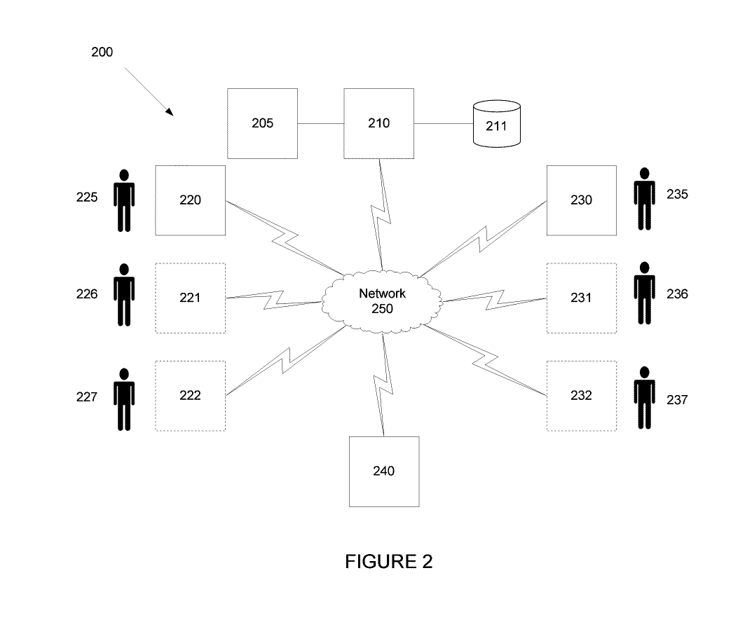

Referring to FIG. 2 there is shown a block diagram representing a network of processing systems 200 which can be utilised to embody or give effect to a particular embodiment. In particular the network of processing systems 200 includes a server processing system 210 in data communication, via a network 250 such as the Internet, with one or more seller terminal systems 220-222 associated with one or more respective sellers 225-227, and one or more bidder terminal systems 230-232 associated with one or more respective bidders 235-237. Optionally, the network of processing systems 200 can include a financial transaction processing system 240 for coordinating transfer of funds between a bidder 235-237 and seller 225-227 in the real time auction. The server processing system 210, the one or more seller terminal systems 220-222, and the one or more bidder terminal systems 230-232 may be provided in the form of processing system 100 which can be a distributed system or a single machine.

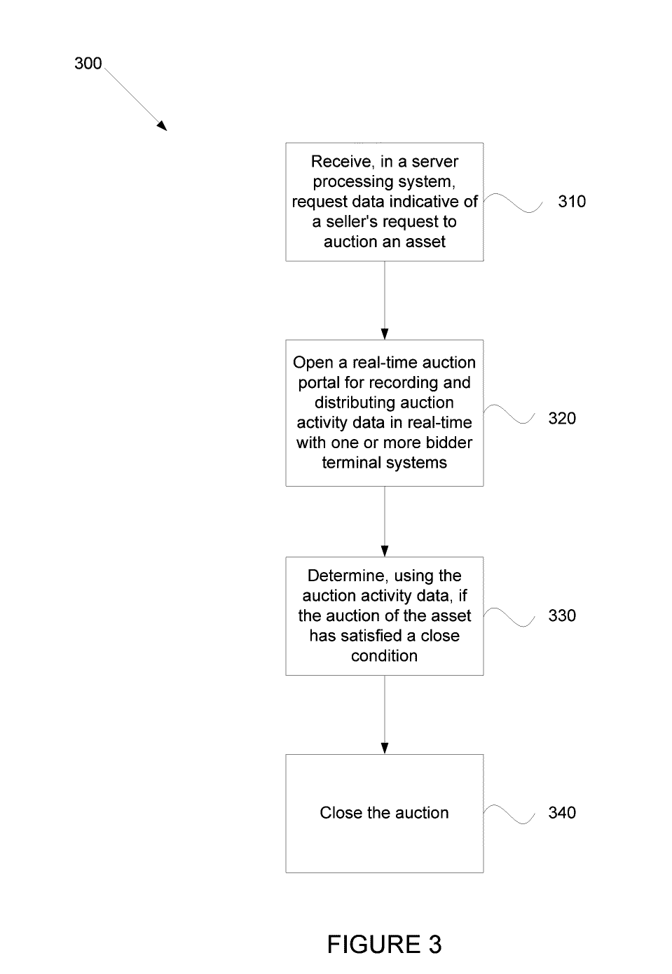

Referring to FIG. 3 there is shown a flow chart representing an example method 300 for conducting a real time auction. In particular, at step 310, the method 300 includes receiving, from a seller terminal system 220-222, request data indicative of a seller's request to auction an asset. At step 320, the method 300 includes opening a real-time auction via an auction portal hosted by the server processing system 210 for auctioning the asset, wherein the server processing system 210 is able to receive and distribute auction activity data in real-time to and from one or more bidder terminal systems 230-232. At step 330, the method 300 includes determining, using the auction activity data, if the auction of the asset has satisfied a close condition of the real-time auction. At step 340, the method 300 includes closing the real time auction of the asset in response to the close condition being satisfied.

As the auction activity data is distributed by the server processing to the one or more bidder terminals 230-232, a real time auction can be conducted. Additionally, as the auction activity data is used for determining the closing condition of the real time auction, traditional auction strategies, which are not normally associated with computer implemented auctions, can be utilised by a bidder 235-237 in order to compete in the real time auction. Furthermore, as a seller 225-227 is able to transfer a request to auction an asset utilising the network of processing systems, the seller 225-227 is able to advantageously sell the asset without having to physically consign the asset to an auction house or the like.

Similarly, a server processing system 210 can be provided which conducts the real time auction. In particular, the server processing system 210 is configured to: receive, from a seller terminal system 220-222, request data indicative of a seller's request to auction an asset; open a real-time auction via an auction portal hosted by the server processing system 210 for auctioning the asset, wherein the server processing system 210 is able to receive and distribute auction activity data in real-time to and from one or more bidder terminal systems 230-232; determine, using the auction activity data, if the auction of the asset has satisfied a close condition of the real-time auction; and close the real time auction of the asset in response to the close condition being satisfied.

In another form there is provided a computer program product for conducting a real time auction. The computer program product includes computer executable code which when executed on a suitable programmed server processing system 210, causes the server processing system 210 to: receive, from a seller terminal system 220-222, request data indicative of a seller's request to auction an asset; open a real-time auction via an auction portal hosted by the server processing system 210 for auctioning the asset, wherein the server processing system 210 is able to receive and distribute auction activity data in real-time to and from one or more bidder terminal systems 230-232; determine, using the auction activity data, if the auction of the asset has satisfied a close condition of the real-time auction; and close the real time auction of the asset in response to the close condition being satisfied.

The computer program product can be provided in the form of a computer readable medium. The term “computer program product” as used herein refers to any storage or transmission medium that participates in providing instructions and/or data to the processing system 100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the processing system 100. Examples of transmission media include radio or infra-red transmission channels as well as a network connection to another computer or networked device, and the Internet or Intranets including e-mail transmissions and information recorded on Websites and the like.

In another form there is provided a method of participating in a real time auction. In particular, the method includes, in a bidder terminal system 230-232, steps of: receiving and transferring auction activity data in relation to a real time auction via an auction portal hosted by a server processing system 210 for auctioning an asset; and receiving, from the server processing system 210, closing condition data indicative of a close condition of the real time auction being satisfied, wherein the server processing system 210 determines whether the closing condition is satisfied based upon auction activity data.

Similarly, in one form there is provided a bidder terminal system 230-232 for participating in a real time auction, wherein the bidder terminal system 230-232 is configured to: receive and transfer auction activity data in relation to a real time auction via an auction portal hosted by a server processing system 210 for auctioning an asset; and receive, from the server processing system 210, closing condition data indicative of a close condition of the real time auction being satisfied, wherein the server processing system 210 determines whether the closing condition is satisfied based upon auction activity data.

In another form there is provided a computer program product for participating in a real time auction. The computer program product includes computer executable code which when executed on a suitable bidder terminal system 230-232, causes the bidder terminal system 230-232 to: receive and transfer auction activity data in relation to a real time auction via an auction portal hosted by a server processing system 210 for auctioning an asset; and receive, from the server processing system 210, closing condition data indicative of a close condition of the real time auction being satisfied, wherein the server processing system 210 determines whether the closing condition is satisfied based upon auction activity data.

The real time auction system 200 which is provided by the server processing system 210 is generally provided in the form of an Internet accessed webpage which both bidders 235-237 and sellers 225-227 can access via an Internet browser or similar means. Preferably the server processing system 210 executes an auction server program, herein referred to as an auction server 205, which controls the operation the one or more real-time auctions. Preferably the bidders 235-237 and the sellers 225-227 are required to log into the real time auction system 200 in order to participate in the real time auction, such as offering an asset for auction or placing a bid in an auction. It will be appreciated that non-registered users may be able to view the real time auction as a mere spectator in order to assess the operation of the real time auction system 200, however, it is not possible, without registration, that a spectator can participate in the real time auction.

Upon logging into the real time auction system 200 which is administered by the server processing system, a bidder 235-237 and a seller 225-227 are presented with a menu screen, which is generated and transferred by the server processing to the respective terminal(s), which allows the particular user to be able to control their participation in the real time auction system 200. Particular features which are presented in the menu screen may be specific to the type of user, that being a buyer or a seller 225-227, and thus the functions presented may differ. It will be appreciated that a particular user of the real time auction system 200 can be both a bidder 235-237 and a seller 225-227.

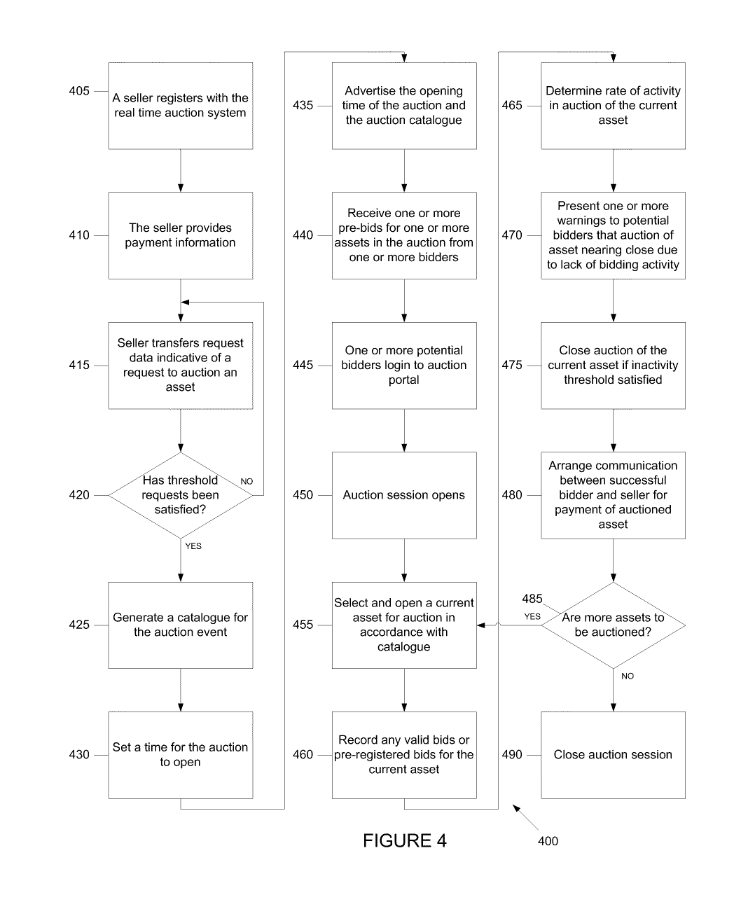

Referring to FIG. 4 there is shown a more detailed flow chart illustrating a method of participating in and conducting a real time auction. The examples discussed in relation to FIG. 4 are in relation to a plurality of assets being auctioned as a group during an auction session. However, it will be appreciated that a single asset can be auction during an auction session.

In particular, at step 405, a potential seller 225-227 registers with the server processing system 210 in order to participate in the real time auction.

In the event that the seller 225-227 has previously registered with the system, the method includes logging the seller 225-227 into the real time auction system 200 such that the method continues onto step 415.

In the event that the seller 225-227 has not previously registered with the real time auction system 200, the seller 225-227 can be presented, via the seller terminal system 220-222, one or more registrations forms contained in a registration webpage hosted by the server processing system 210. The seller 225-227 completes and submits the registration webpage using one or more input devices of the seller terminal system 220-222, wherein registration data is transferred to the server processing system 210 for recordal in a data store 211, such as a database.

The seller 225-227 may be required to provide information such as the seller's name, company name, company identifier (such as a business number), a postal address, email address, financial account details, a date of birth of the seller 225-227, a password (which may be requested to be provided twice in order to avoid errors in data collection), a secret question and answer in order to identify the seller 225-227 if the password is forgotten, an indication that terms and conditions of use of the real time auction system 200 have been agreed to by the seller 225-227, an indication whether the seller 225-227 authorises communication to be received from an auctioning entity associated with the server processing system 210, and an indication that the seller 225-227 is over a particular legal age limit to use such as service.

It will be appreciated that some fields of the above seller information are merely optional and therefore inessential. It will also be appreciated that particular data may be verified for accuracy by the server processing system 210. For example, the server processing system 210 may determine whether the email address provided follows normal email address structure, wherein in the event that the email address in invalid, the seller 225-227 is requested to resubmit a valid email address. Particular data fields, such as a password and financial details (i.e. credit card or bank account details) received by the server processing system may be encrypted prior to storage in the data store 211.

At step 410, the seller 225-227 is requested to input payment information in order to participate as a seller 225-227 in the real time auction. Generally, payment information may include credit card details, or other means such as funds transfer systems such as PayPal, telegraphic transfer, or the like. Payment data is securely transferred to the server processing system 210 for recordal and processing to ensure valid payment information has been provided by the seller 225-227. The seller 225-227 may then be requested to confirm that the seller registration information and payment information is correct via a confirmation webpage, wherein the seller 225-227 may be presented with the submitted information to confirm the accuracy of the information. Upon the seller 225-227 indicating the accuracy of the submitted information via one or more of the input devices of the seller terminal system 220-222, the data is recorded and/or processed accordingly by the server processing system 210. The seller 225-227 can be sent an email to confirm payment and to welcome them to the real time auction system 200. The seller 225-227 is then able to use a username and a password to log into the real time auction system 200 wherein a seller 225-227 is displayed a seller interface where details for the seller 225-227 can be changed and the seller 225-227 can interact with the real time auction system 200.

At step 415, upon the seller 225-227 being presented with a seller interface in the form of a webpage, the seller 225-227 is able to preview data relating to any auction associated with the respective seller 225-227. A seller 225-227 is also able to request that an auction is conducted for new asset using the real time auction system 200.

In particular, the method includes the seller 225-227 transferring, to the server processing system 210, a request to auction an asset using the real time auction system 200. The seller 225-227 may be presented with one or more forms to complete so as to request an asset to be auctioned in the real time auction system 200, wherein the seller 225-227 may complete and submit the one or more forms using one or more input devices of the seller terminal system 220-222.

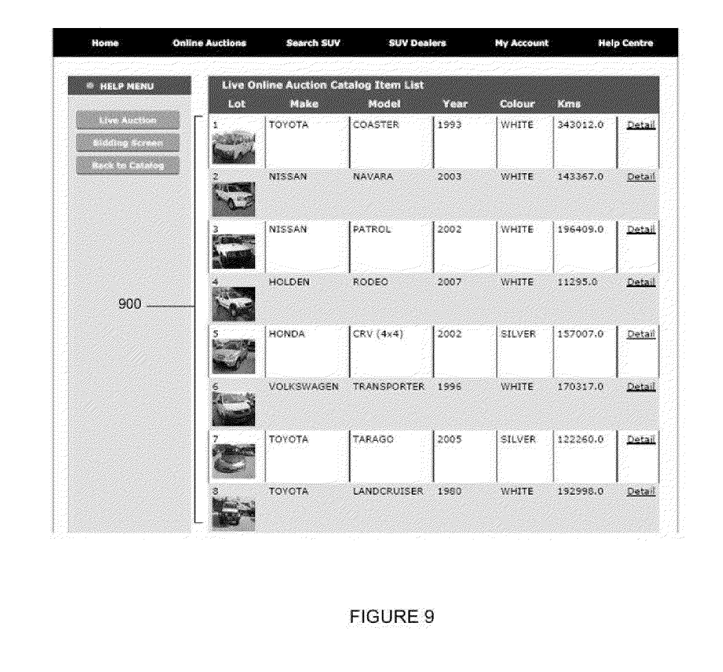

The one or more forms may be presented in the form of a webpage. The seller 225-227 is generally requested to provide a description of the asset available for auction. Graphical data indicative of one or more pictorial representations of the asset available for auction may also be submitted to the seller terminal system 220-222 via the one or more online forms. In one form, the seller 225-227 may be requested to provide categorisation data indicative of a category which describes the asset to allow similar assets to be auctioned together in a group 900 in an auction session, as illustrated in FIG. 9. In another optional embodiment, the seller 225-227 may be requested to provide selling criteria such as a reserve price.

In another form, property fields may be populated regarding particular properties of the asset. For example, in the event that the asset is a vehicle, the property fields requested from the seller may include one or more of the following: make, model, series, registration number, chassis or vehicle identification number, engine number, year of manufacture, status (i.e. used, new), odometer reading, transmission type, graphical location of vehicle, model variations, expiration date of registration, body type, engine size, colour, type of fuel consumed, and/or trim colour. In an optional embodiment, upon the seller indicating and transferring the category of the asset to the server processing system, the server processing system 210 can transfer, to the seller terminal system, an asset property data request indicative of a form for collecting properties of the asset from the seller.

Upon the seller 225-227 submitting the auction request, auction request data is transferred to the server processing system 210 for processing and/or recordal in a database 211.

At step 420, the method includes the server processing system 210 determining whether a threshold number of auction requests have been received to conduct an auction session.

In particular, the server processing system 210 may be configured by an administrator entity to conduct an auction session only once a particular number of assets have been requested to be auctioned by one or more sellers 225-227.

In one form, the administrator may set a threshold rule in the server processing system 210 indicating that once a particular number of auction requests are received, an auction session can subsequently be conducted. In another form, the administrator may set a threshold rule in the the server processing system 210 indicating that a particular number of assets of a category must be available for auction prior to conducting an auction session.

For example, using the categorisation data provided by the one or more sellers 225-227, assets can be logically grouped together into asset groups 900, wherein the server processing system 210 can determine whether a threshold number of requests for a particular group of assets 900 has been established in order to hold an auction session. However, it will be appreciated grouping assets using a category is not essential. For example, assets may grouped randomly or using other techniques.

It will be appreciated that the administrator can modify the threshold rule in the server processing system to determine when an auction can be conducted. It will also be appreciated that it is possible that different threshold rules can be set for different asset categories. In the event that a threshold rule has not been satisfied, the server processing system 210 continues to wait and receive further auction requests at step 415. In the event that a threshold rule has been satisfied, the server processing system 210 continues to step 425.

At step 425, the method includes the server processing system 210 generating a catalogue for a real time auction session. The server processing system 210 may determine the catalogue for the real time auction session based on the order in which auction requests were received, wherein the oldest received request is the first asset to be auctioned in the real time auction session, and the most recent received request is the final asset to be auctioned in the real time auction session. In an alternate form, the assets for auction may be randomly ordered independently of the age of each auction request.

The server processing system 210 can also use at least a portion of the description of each asset provided by each seller 225-227 to generate the catalogue. The catalogue can be provided in the form of a publicly accessible webpage available via the real time auction system 200 and/or a transferred electronic file which can be distributed to potential bidders 235-237 for review. Each asset listed in the catalogue can be provided with a sequential lot number to identify the asset.

The catalogue can define a sequential order of real time auctions for the respective assets of the asset group 900. A particular asset in the catalogue is available for bidding during the auction session only when the previously listed real time auctions in the catalogue have closed. However, as discussed below, a proxy bid may be placed prior to the real time auction for a particular asset. In one form, the catalogue can include a portion of the description of the asset, graphical data such as one or more photographs or graphics of the asset, and a hyperlink to a webpage hosted by the server processing system 210 which includes a full description of the asset.

At step 430, the method includes setting an opening time and date for at least some of the real time auctions of the group 900. In the event that a group of assets 900 are to be auctioned sequentially, only a single opening time for the first auction of the first asset in the group of auctions 900 need be set by the server processing system 210. Therefore, in one optional form, none of the auctions, other than the first auction in the group of auctions 900, have a defined opening or closing time which is similar to a live auction house wherein the opening or closing time of a particular auction of an asset in a group of auctions 900, other than the first asset, are dependent upon the amount of bidding activity which occurred for previous auctions in the group 900.

In an alternate embodiment, the server processing system 210 may define an earliest opening time for each auction in the group of auctions 900. In this alternate embodiment, in the event that an auction in a group of auctions 900 closes earlier than anticipated as defined by the earliest opening time for the next asset in the group 900, the real time auction system 210 may wait until the earliest opening time for the next auction in the group 900 is reached prior to opening the next auction for the next asset in the group 900. In the event that an auction closes later than anticipated as defined by the earliest opening time for the next asset in the group 900, the real time auction system 200 proceeds with opening the next real time auction in the group 900 without waiting. In this alternate embodiment, the real time auction system 200 may use one or more auction period variables set within the server processing system 210 to define the earliest opening time for each auction, except the first auction, in the group of auctions 900. The one or more auction period variables may be set by an administrative entity which administers the server processing system 210. Alternatively, the server processing system 210 may use historical data indicative of the temporal length of one or more previous auctions for similar assets (i.e. assets of the same category) to determine the earliest opening time for each auction in the group 900 other than the first auction.

The server processing system 210 may also be configured to determine the time for the real time auctions does not collide with another real time auction being hosted by the auction server 205 of the server processing system 210. However, this is not essential as will be discussed in more detail below in relation to temporally overlapping auctions.

At step 435, the method includes advertising the real time auctions prior to the real time auction session opening. In particular, the catalogue and the opening time of the real time auctions are advertised prior to the real time auction session opening. In one form, the real time auctions can be advertised via a webpage. Additionally or alternatively, the real time auctions can be advertised via email. In one form, registered potential bidders 235-237 are able to store in a database 211 associated with server processing system 210, asset categories of interest specific for the potential bidder 235-237. In this form, the server processing system 210 may conduct a search of the database 211 to determine any registered potential bidders 235-237 who have registered an interest in an asset category which corresponds to the categorisation of the group of real time auctions, wherein an advertisement of the real time auction is emailed from the server processing system 210 to the relevant registered potential bidders 235-237. It will be appreciated that the auction may be advertised prior to the auction opening using other methods such as via newspapers, magazines, radio, television, mail, and the like.

At step 440, the method includes receiving one or more proxy bids from one or more potential bidders 235-237 for one or more assets available in the group of real time auctions. In particular, one or more potential bidders 235-237 are able to login to a bidders interface prior to the auction for the asset being open, and register a proxy bid which is stored in the database 211 associated with the server processing system 210. When the auction for the relevant asset opens, the server processing system can perform a search of the database 211 to determine whether one or more proxy bids have been received from one or more bidders 235-237. If multiple proxy bids have been received from more than one bidder, the server processing system 210 may select, from the database 211, the highest proxy bid to submit on behalf of the relevant bidder 235-237 in the auction. When a bidder 235-237 submits a proxy bid, the bidder 235-237 is able to submit an incremental raise of the bid, a highest bid and a starting bid. The proxy bid is stored by the server processing system in the database 211 in association with the asset of the auction which the respective bidder 235-237 wishes to bid upon. For example, a bidder 235-237 may register with the server processing system 210 a proxy bid including a starting bid of five dollars, a highest bid of twenty dollars, and an incremental bid of two dollars. In this situation, if another bid is registered which is above the starting bid of the proxy bid, the server processing system 210 automatically submits, to the auction server 205, another bid on the bidder's 235-237 behalf with an incremental increase in the bid of two dollars. Only once the current accepted bid for the asset is equal to or higher than bidder's highest bid for the proxy bid does the server processing system 210 stop submitting bids on the bidder's behalf to the auction server 205.

In one form, when a bidder requests, via the bidder terminal, that a proxy bid is to be submitted by the server processing system 210 on behalf of the bidder, the server processing system may recommend a highest bid value to the bidder based upon performing a search of historical sales data for sale prices of similar assets. The server processing system 210 may search the historical sale data based upon the property data for the respective asset in order to determine substantially similar assets which have sold. The historical sales data may be indicative of assets sold via the real time auction system 200. However, the historical sales data may be sales of assets that occurred remote from the real time auction system 200.

The server processing system 210 may also issue a query to a valuation processing system in order to determine a value of the asset based upon the properties of the asset. The valuation processing system may be remote to the server processing system 210. The valuation processing system may return, to the server processing system 210, the estimated value of the asset which can be used in determining the highest bid value for the proxy bid request.

The server processing system 210 may then determine a highest bid value which the server processing system 210 recommends as the bidder's highest bid value which the server processing system 210 may submit as a bid during the auction of the respective asset. The server processing system 210 may use the historical sale prices of the substantially similar assets to calculate an average sales price which the server processing system can recommend to the bidder as the highest bid value to be submitted by proxy. In the event that an estimated value has been obtained via the valuation processing system, the server processing system 210 may weight the average sales price and the estimated value to determine the highest bid value for the respective asset. In another variation, the server processing system 210 may determine a similarity rating between the asset and the search results, wherein the similarity rating can be used to weight the average sale price used for determining the highest bid value.

Upon presenting the recommended highest bid value to the bidder, the bidder may submit adjustment data, to the server processing system 210 via the bidder terminal system, in order to adjust the highest bid value used for the proxy bid. The adjustment data may be indicative of increasing or decreasing the maximum bid which can be submitted by the server processing system 210 to the auction server 205 during the auction on the bidder's behalf.

The server processing system 210 may also present to the bidder, via the bidder terminal system and using the results from the conducted search of the historical sales data, a lowest sale price for a substantially similar asset, and a highest sale price for a substantially similar asset. The bidder can then take these sale prices into account when considering whether adjustment data need be submitted to the server processing system 210 for the adjusting the highest bid price for the particular asset.

The server processing system 210 may also periodically review the listing of the asset for the requested proxy bid service, wherein in the event that details of the listing are at least partially altered prior to the auction for the asset opening, the server processing system 210 may transfer a message, in the form of an email/SMS or other communication medium, to the proxy bidder to inform of the change and request whether the highest bid value require altering. In one form, the message transferred may include an updated recommended highest bid value, calculated using similar techniques described above, which the user can accept or adjust accordingly. Otherwise, the proxy bidder may be offered the option to cancel the proxy bid in light of the changes to the listing of the asset for auction.

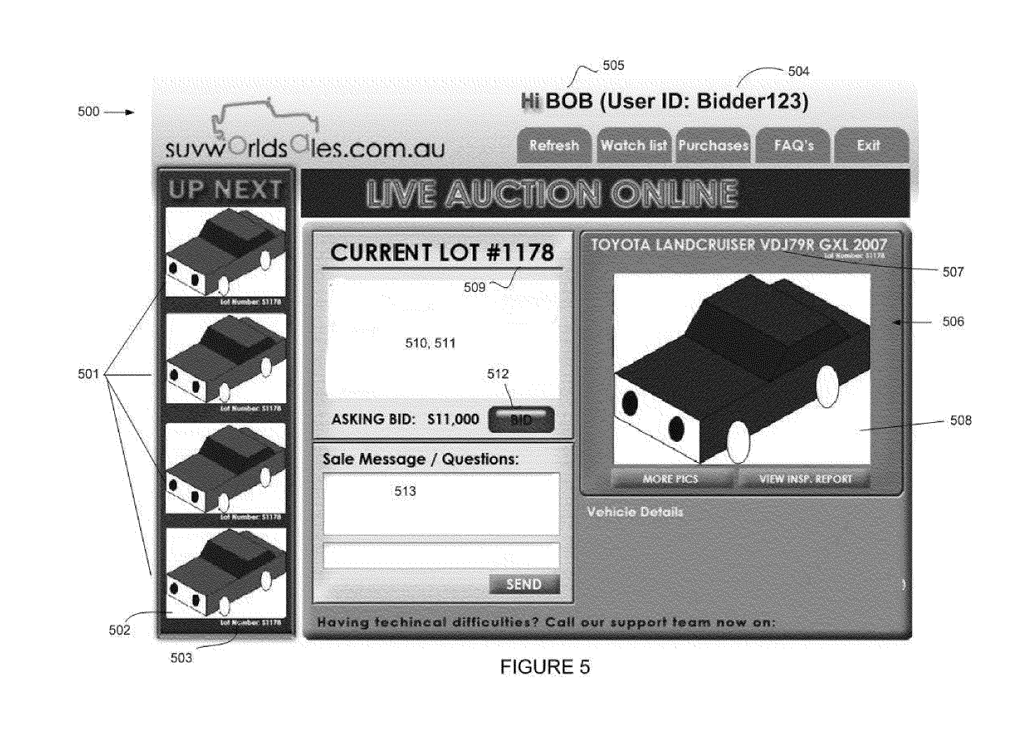

At step 445, one or more bidders 235-237 login to the real time auction interface, wherein an example bidder interface is provided in FIG. 5. In this example, the one or more bidders 235-237 login to the real time auction interface prior to the auction session opening. However, it will be appreciated that one or more bidders 235-237 are able to login to the real time auction session after an auction has opened. However, it will also be appreciated that as each auction occurs in real time, a bidder 235-237 who fails to login to the real time auction system 200 prior to an auction of an asset closing is unable to make a bid in the respective auction for the asset.

At step 450, the auction server 205 of the server processing system 210 declares the auction session open for the group of assets available for auction. The auction server 205 may be launched by the server processing system 210 in order to conduct the real-time auctions. Data is transferred from the auction server 205 of the server processing system 210 to each bidder terminal 230-232 which has logged into the real time auction system 200 indicating that the auction session for the one or more auctions has been declared open.

At step 455, the auction server 205 of the server processing system 210 selects an asset for auction in accordance with the catalogue. Thus, as a particular sequential order of assets is defined in the catalogue, the auction server 205 of the server processing system 210 selects an asset which is next in the list to be offered for auction. In the event that no assets have previously been sold, the first asset can be selected to be offered for auction. Upon selection, data is distributed to each logged in potential bidder 235-237 that the selected asset is open for auction and awaiting any bids. Graphical data, such as a photograph of the asset, is transferred to each logged in bidder 235-237, wherein the bidding interface displays the graphical data to each bidder 235-237 using the bidder terminal system 230-232.

At step 460, the method may include the auction server 205 of the server processing system 210 registering a bid in relation to the current asset for auction. The registration of a bid can include receiving a valid bid from one of the logged in bidders 235-237 or a proxy-bid pre-registered with the server processing system 210. In one form, in the event that more than one proxy-bid has been registered for the current asset, the auction server 205 of the server processing system 210 determines which proxy bid has a higher allowable bid based upon the highest bid value stored within the database 211, wherein the proxy bid for the respective bidder is registered. When the auction activity data is transferred to each of the logged in bidders 235-237, the accepted proxy-bid is shown as being the current accepted bid for the asset. It will be appreciated that if the asking opening bid for the auction, as will be discussed in detail below, is higher than the highest bid value for all proxy bids, then no proxy bids may be registered as being accepted for the auction.

When a proxy bid is submitted by the server processing system 210 to the auction server 205 on behalf of a bidder, the server processing system 210 may transfer to the bidder, via one or more communication mediums such as email, SMS or the like, a message indicating that a proxy bid has been submitted and the value of the bid submitted on the bidder's behalf. In the event that the current accepted bid in the auction exceeds the highest bid value for a proxy bid registered by the bidder with the server processing system 210, the server processing system may transfer a message, via one or more communication mediums such as email, SMS or the like, indicating that the current bid accepted in the auction exceeds the bidders highest bid value for the proxy bid. The message may also indicate the current bid value accepted in the auction.

In the event that the bidder associated with the registered proxy bid wishes to change the highest bid value whilst the auction for the asset is still open, the bidder may transfer adjustment data to the server processing system, via a communication medium such as email, SMS, interaction with a web-interface via a bidder terminal system, or the like, in order to adjust the highest bid value for the proxy bid. Upon receiving the adjusted highest bid value of the proxy bid for the bidder, the server processing system 210 stores this value in the database 211 and attempts to submit another proxy bid for the bidder according to the adjusted proxy bid details with the auction server 205.

When one of the bidders 235-237 submits a bid in the real time auction, the bid can be validated at the bidder terminal system 230-232, such as via the use of Javascript or the like, and/or at the auction server 205 of the server processing system 210 such that only a valid bid is accepted. For example, a bid which is attempted to be submitted by one of the bidders 235-237 can be compared against the current highest bid to ensure only a higher bid is registered. This comparison can occur at both the bidder terminal 230-232 as well as the auction server 205 of the server processing system 210, wherein in the event that an invalid bid is attempted to be submitted, an error message is presented to the relevant bidder 235-237 and the invalid bid is restricted from being registered by the auction server 205 of the server processing system 210 and restricted from being distributed to the other logged in bidders 235-237.

In the event that a valid bid is received by the auction server 205 of the server processing system 210, the bid is registered in the database 211 associated with the asset for auction, wherein a timestamp indicative of when the bid was registered is also stored in association with the new bid data in the database 211. Auction activity data indicative of the newly registered bid is distributed to each of the bidders 235-237 near-immediately and in real time. Thus, logged-in bidders 235-237 are notified, of the new auction activity that has occurred in relation to the auction of the asset. Each bid submitted may be transferred via a message to one or more proxy bidders registered for the auction of the asset via one or more communication medium as discussed above.

At step 465, the method includes the auction server 205 of the server processing system 210 determining a rate of auction activity in relation to the auction of the asset. In one form, the auction server 205 of the server processing system 210 may monitor an elapsed amount of time from the last bid received or the opening of the auction for the asset. In additional or alternate forms, input device activity, such as keyboard or mouse activity, at each bidder terminal system 230-232 may be collected by the auction server 205 of the server processing system 210 in order to determine a rate of auction activity and whether one or more warning thresholds have been satisfied. By determining a rate of auction activity, one or more warning conditions and the close condition of the auction can be controlled by the auction server 205 of the server processing system 210 in a manner similar to a real site auction, thus allowing remote bidders 235-237 to use bidding strategies which are permissible in real site auctions.

Once the rate of auction activity satisfies one or more warning thresholds, the method includes, at step 470, distributing to each of the logged in bidders 235-237, one or more closing warnings indicating that the auction is nearing a close condition. The one or more warnings are presented, in a visual and/or audio medium, via the bidder interface. In response, a new bid can still be submitted by one of the logged in bidders 235-237, wherein the rate of auction activity may be reset or recalculated to continue allowing valid bids to be submitted. In one form, the warning data may be provided in the form of a countdown timer indicating an amount of time remaining for the auction prior to a closing condition of the auction being met.

At step 475, the auction server 205 of the server processing system 210 determines whether the auction activity meets a close condition threshold. In the event that the threshold has not been satisfied, the auction remains open such that a bid can be submitted. However, in the event that the close condition threshold is satisfied, the method includes the auction server 205 of the server processing system 210 closing the auction wherein no further bids are able to be accepted in relation to the asset. Data is transferred from the auction server 205 of the server processing system 210 to the logged in bidders 235-237 indicating that the auction of the current asset has closed. Additional information may also be distributed to the logged in bidders 235-237 including the winning bid value and the winning bidder. As discussed above, one or more messages may be transferred to proxy bidders accordingly.

A message may be transferred to the winning bidder, via one or more communication mediums such as email, SMS or the like, indicating that the asset has been won at the auction.

At step 480, the method includes the server processing system 210 arranging payment from the winner bidder 235-237 to the seller 225-227. In one form, the winning bidder may be presented, by the server processing system, a hyperlink to a financial transaction webpage in order to authorise the financial transaction to the seller. Financial data can be processed by the server processing system 210 or alternatively the financial data can be transferred to the financial transaction processing system 240 for processing.

Alternatively, the method includes arranging communication between the winner bidder 235-237 and seller 225-227 such that payment of the asset can be made. In one form, contact details of the seller 225-227 and bidder 235-237 are swapped in order to arrange payment for the asset won in the auction. More specifically, the seller's email address is disclosed to the winning bidder 235-237, and the wining bidder's email address is disclosed to the seller 225-227. The disclosure of the email addresses can be performed by email or the like. Additionally or alternatively, communication between the winning bidder 235-237 and seller 225-227 can be relayed via the server processing system 210 such that email addresses and the like are not disclosed to either party. The payment of the asset may be performed via an escrow system utilising the financial transaction processing system 240. The escrow system may be utilised by the winning bidder 235-237 and seller 225-227 via the network 250.

At step 485, the method includes determining, in accordance with the catalogue, whether any further assets are available for auctioning in the real time auction session. In the event that one or more further assets are available in the catalogue, the method proceeds back to 455.

In the event that no further assets are available for auction in the real time auction, the method proceeds to step 490, wherein the auction session is closed. In this instance, closing data is transferred to the logged in bidders 235-237 indicating that the real time auction session has closed. Proxy bidders may also be notified accordingly via one or more communication mediums discussed.

In one form, when a bidder 235-237 logs into the real time auction system 200, the bidder 235-237 is able to view assets previously won in the real time auction system 200. Additionally, data indicative of bids submitted in one or more auctions can be presented to the bidder 235-237.

Referring to FIG. 5, the bidder interface 500 presents one or more upcoming assets 501 for auction. In one form, the bidder interface 500 displays a short description, such as an asset title or lot number 502, and a graphic 503 of next assets which are available for auction in the auction session. The bidder interface 500 also displays the bidder's name 505 and username 504, a current asset 506 for auction, an asset description 507, a lot number associated with the current asset 509, a bidding window presenting the current bid 510, a bid history 511, and a bidding button 512 which allows the buyer to place a bid. The bidder interface 500 also provides a message section 513 which allows a bidder 235-237 to submit a question regarding the current asset being auctioned, wherein the question data is transferred to the administrator and/or the seller 225-227 in real time. The seller 225-227 or the administrator and/or the seller 225-227 can answer the bidder's question, wherein answer data indicative of the answer can be transferred to the relevant bidder terminal 230-232 for display in the bidding interface 500. In an optional form, other forms of media, other than graphical, can be presented indicative of the asset in the bidding interface. For example, media such as audio and video can be presented in a streaming manner in the bidding interface. Each bidder may interact with the respective bidder's interface to selectively adjust the media presented for the real time auction session.

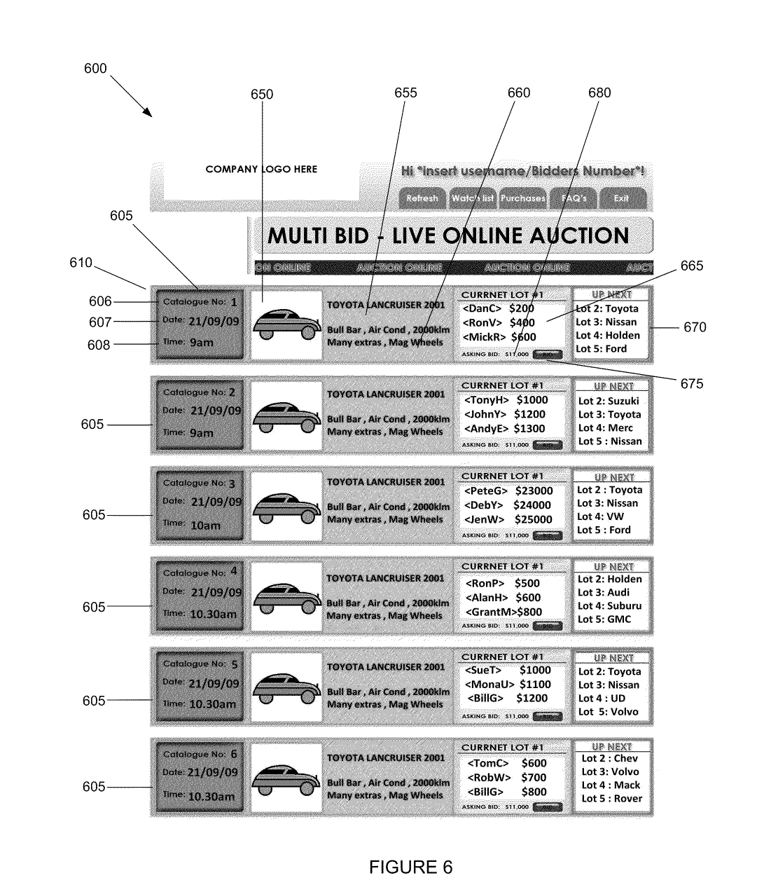

Referring to FIG. 6 there is shown a further example of a bidding interface 600 to allow one or more bidders to participate in multiple real time auction sessions in a temporally overlapping period. As multiple auctions in different auction sessions for different auction groups 900 may be run simultaneously by the auction server 205 of the server processing system 210 such that they are temporally overlapping, the user can be offered the option, via the bidding interface 600, to select a plurality of auction sessions which are expected to have at least some overlap in time.

Once the bidder has indicated to the auction server 205 of the server processing system 210, via an input device of the bidder terminal 230, that the bidder wishes to be able to participate in temporally overlapping real time auctions, the auction server 205 of the server processing system 210 displays a multiple auction bidding interface 600 as shown by example in FIG. 6. The multiple auction bidding interface 600 can be displayed to the bidder in a tabular format, wherein each row presents information about an individual real time auction 605, wherein each real time auction is an auction lot for one or more assets. Information 610 that is presented about each real time auction 605 in the multiple auction bidding interface 600 can include a catalogue number 606, date 607 of the respective auction, time 608 that the respective auction commences, a graphical representation 650 of the asset being auctioned, a description 655 of the asset, lot details 660, a real time auction feed 665 indicative of the auction activity for the respective real time auction, an indication of a current bid 680 for the asset, a bid input control 675, and an indication of one or more upcoming lots 670 of the respective auction. As can be seen in FIG. 6, the bidder is able to submit a bid in any one of the real-time auctions 605 being conducted in a plurality of auction sessions which temporally overlap.

In one form, when the server processing system 210 receives data indicative of the bidder wishing to participate in temporally overlapping real time auctions, the server processing system executes a query to determine a plurality of auction sessions that have an overlap in duration. The server processing system 210 transfers data to the bidder terminal 230 indicative of the auction sessions which overlap which is presented to the bidder. The bidder is able to make a selection of the overlapping auction sessions which are to be displayed via the multiple auction bidding interface 600, wherein data is transferred to the server processing system 210 from the bidding terminal 230 indicative of this selection of overlapping auction sessions by the bidder. The sever processing system 210 then generates, using the selection data received from the bidding terminal 230 and the auction server 205, data indicative of the multiple bidding interface 600 displaying information relating to the overlapping auction sessions which run at least partially simultaneously by the auction server 205 such that the auctions temporally overlap. The data indicative of the multiple bidding interface 600 is transferred to the bidder terminal 230 for presentation to the bidder such that the bidder can interact with the multiple auction bidding interface 600.

In one form, as one or more of the auction sessions 605 close, the server processing system 210 updates the multiple auction bidding interface 600 such that each closed auction session is removed from the multiple auction bidding interface 600.

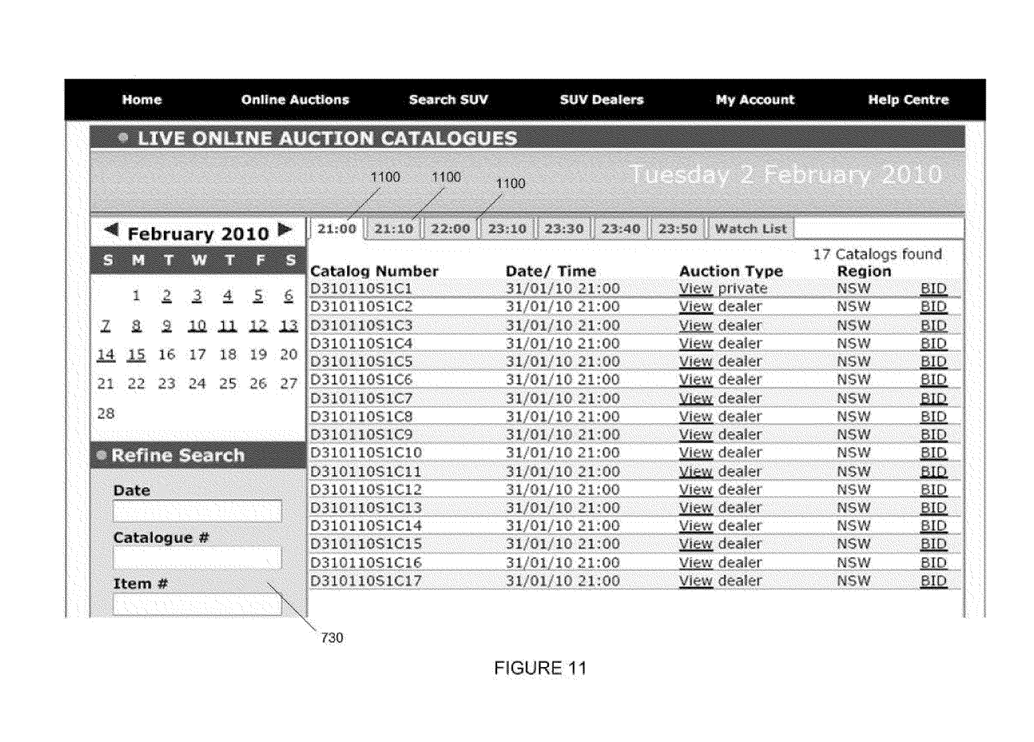

An alternate interface layout for viewing multiple temporally overlapping auctions is illustrated in FIG. 11, wherein a tabbed layout is provided, wherein each tab illustrates an auction session which is to open at a particular opening time. As shown in FIG. 11, the alternate interface layout includes a search function 750 similar to that of FIG. 6, wherein the tabbed layout is adjusted according to the search results.

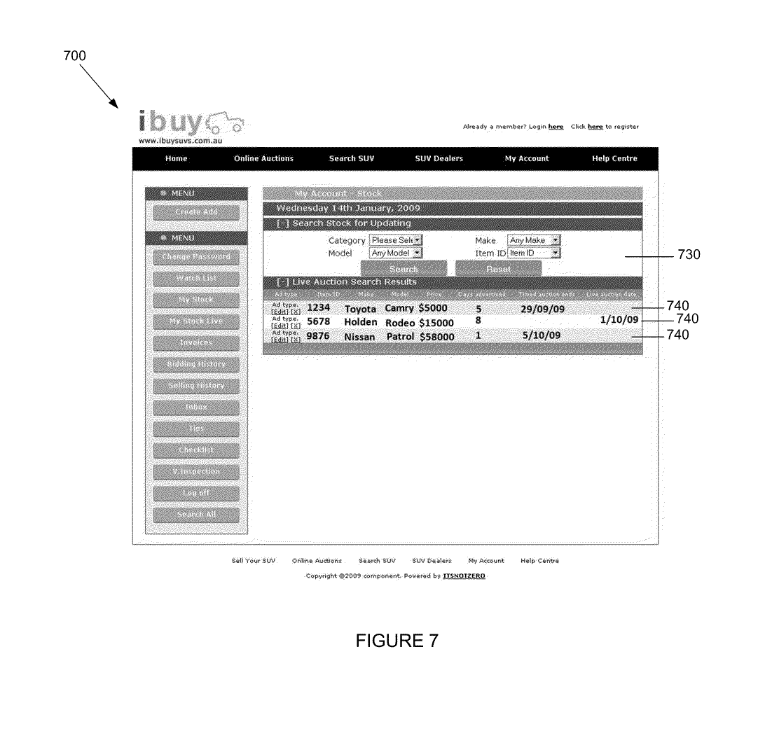

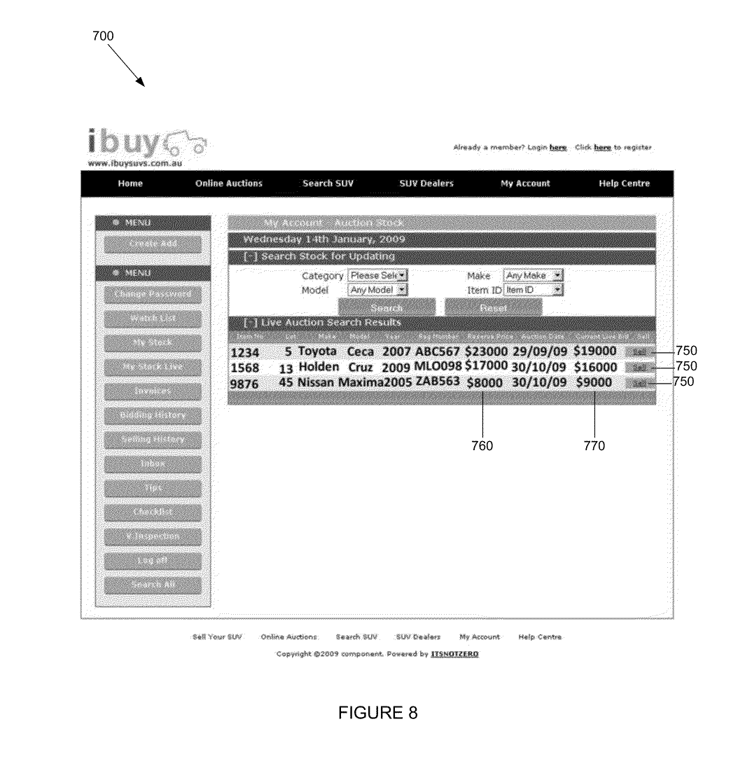

FIGS. 7 and 8 illustrate an example of a seller's interface 700 to allow the seller to provide input during a real time auction. The seller's interface can be provided in the form of an account interface when the seller logs into the auction system as a seller.

The seller's interface 700 includes a live auction frame 740 which presents a current accepted bid for one or more auctions of assets owned by the seller. Details of each respective asset are also presented to the seller within the live auction frame 740. An input button 750 is provided and associated with each asset which is currently being auctioned which allows the seller to adjust a parameter of the auction of the asset. In particular, the seller can adjust the reserve price of the asset to equal the current highest bid 770 that has been received, such that the seller ensures that the asset will sell via the auction.

In one form, the seller may be restricted from adjusting the reserve price of the asset during the auction until one or more closing warnings have been issued to the bidders. For example, in the instance that the closing warning is provided in the form of a “going, going, final call, gone” format which can be periodically issued to the one or more bidders, the server processing system 210 may enable the seller to adjust the reserve price only after the final call has been transmitted by the auction server 205 of the server processing system 210. Specifically, the input button 750 may be disabled until the final call closing warning has been transmitted by the auction server 205 of the server processing system 210. This feature allows the seller to adjust the reserve price dynamically in the event the seller realises the reserve price 760 set for the asset was too ambitious.

As shown in FIG. 7, the seller's interface 700 can also include a search form 730 which allows the seller to input search criteria into the search form such that only assets which satisfy that search criteria are displayed in the live auction frame 740. Once the seller inputs particular search criteria, the search criteria is transferred to the server processing system 210, wherein a search query using the search criteria is executed by the server processing system 210 against the database and wherein the results of the search are transferred and presented to the seller via the seller's processing system 220 within the live auction frame 740.

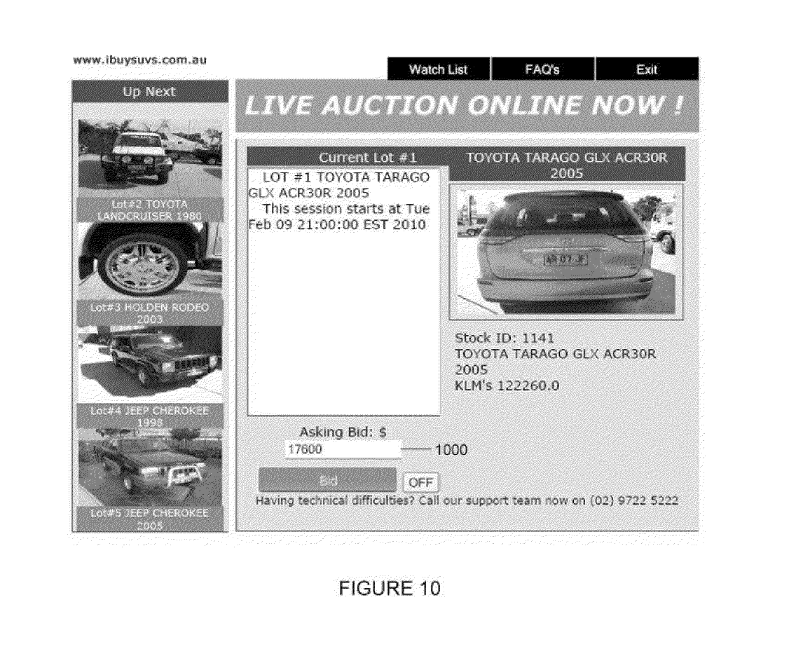

In an optional form, the server processing system 210 can calculate an opening asking bid 1000 for each asset prior to opening the auction for the asset. As shown in FIG. 10, the bid field of the bidding interface includes the opening asking bid amount calculated by the server processing system 210. A valid acceptable bid during the auction may only be considered, by the auction server 205 of the server processing system, to be equalling or exceeding the opening asking bid.

In particular, the server processing system 210 may calculate the opening asking bid 1000 based upon at least one of: a number of impressions, prior the auction, of the website advertising the asset which is hosted by the server processing system; a number of enquires (email, telephone) received in response to the auction of the asset; and the reserve price set by the seller. By weighting the opening asking bid 1000 according to the popularity of the asset which is derived by the number of impressions and the number of enquires, the number of bidders participating in the auction of the asset can be controlled by the server processing system 210 accordingly, thus minimising unnecessary data transfer by the auction server 205 of the server processing system 210. Furthermore, the number of non-winning bids submitted during an auction can be reduced due to the weighting of the opening asking price, thereby again minimising data transferred from, and processing performed by, the auction server 205 of the server processing system 210.

For example, the server processing system 210 may determine the opening asking bid 1000 by calculating a portion of the reserve price weighted by the number of enquires and impressions of the website. The weighting importance applied according to the number of enquires and the number of impressions can be determined by the server processing system 210 analysing historical sales data to determine the importance of the weighting to be applied.

It will be appreciated that the bidder and/or seller terminal systems 230-232, 220-222, can be provided in the form of a mobile telephone device or similar.

It will be appreciated that the registration process described in relation to method 400 for a seller 225-227 can be used for bidders 235-237 to register with the real auction system.

In one form, a bidder 235-237 can submit reminder request data to the server processing system 210, wherein the reminder request data is indicative of one or more assets which the bidder 235-237 wishes to be reminded about when the asset is to be auctioned. The reminder can be sent via email, SMS or similar.

In a preferable form, when a seller 225-227 or bidder 235-237 wishes to interact with the real time auction system 200, a username and password combination is used to log into the system. It will be appreciated that a non-logged in user is restricted from submitting a bid in the auction.

In one variation, in the event that a bid for an asset fails to reach a reserve price set by the bidder 235-237, the server processing system 210 may arrange for communication between the bidder 235-237 which submitted the highest bid and the seller 225-227 in order to attempt to sell the asset. In one form, the email address of the seller 225-227 is provided to the highest bidder 235-237, and similarly the email address of the highest bidder 235-237 is provided to the seller 225-227. In an additional or alternate form, messages can be exchanged between the highest bidder 235-237 and seller 225-227 wherein message data is transferred to the server processing system 210 for relaying to the opposite party to facilitate negotiations.

In another additional form, the auction server 205 of the server processing system 210 may transfer audio data indicative of auction activity data received to one or more bidder and/or seller terminal systems. Each of the bidder and/or seller terminal systems may be configured to interpret the audio data and emit a noise via a speaker or the like. The noise may be indicative of a simulated voice indicating the current bid, the current winning bidder, and/or a closing warning for the respective auction.

In another variation, the auction server 205 of the server processing system 210 may display one or more advertisements within an interface of the real time auction system 210. Advertisers may interact with the server processing system 210 to financially purchase advertising space within the interface of the real time auction system, and submit advertising data to the server processing system 210 for presentation within the interface.

In another form, in the event that an auction fails to reach a reserve price set by the seller 225-227, the server processing system 210 transfers a message to the seller 225-227 confirming that the asset was not auctioned due to failing to meet the reserve price. In one form, this can occur via email. The server processing system 210 may also offer in the message the option of the seller 225-227 to resubmit the asset for another auction wherein the seller 225-227 adjusts the reserve price stored in the database 211 at the server processing system 210.

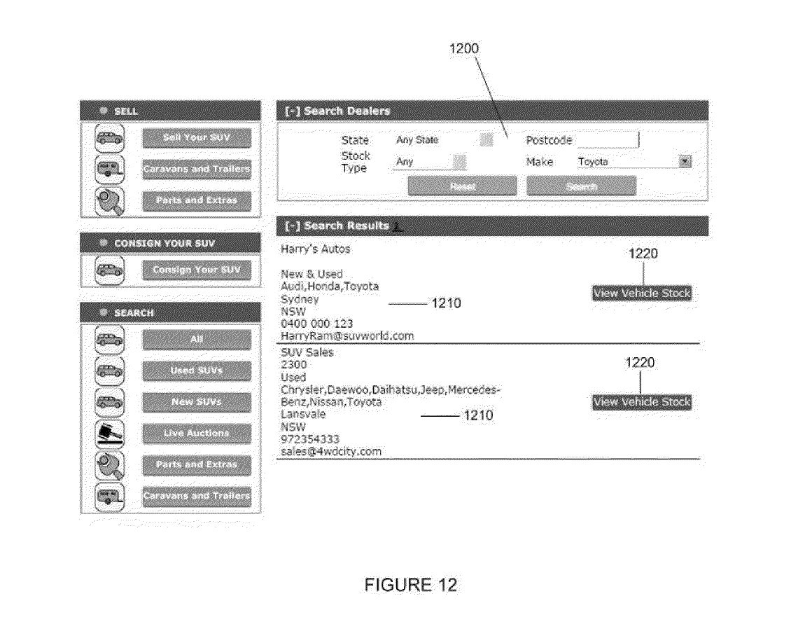

In another form, as shown in FIG. 12, a user (bidder or seller) of the real time auction system 200 may perform a search, using a search interface 1200, for a seller with the real time auction system 210 which satisfies particular search criteria. In particular, the user may search for one or more sellers based upon at least one of: a geographical region or location of the seller, and/or an asset category and/or sub-category. Search results 1210 are transferred from the server processing system 210 to the user terminal system being operated by the user in order for presentation to the user. The user can then interact with the search results to view a particular seller's assets 1220 which are pending auction via the real time auction system 200. For example, in the event that the real time auction system 200 is configured for auctioning vehicles, the user may be able to search for dealerships within a particular geographical area and/or dealers offering particular vehicle makes and models, wherein the search results present particular dealerships which satisfy the search criteria submitted by the user.

Whilst generally a plurality of different sellers are associated with assets which are auctioned in a group, in an optional form a seller may transfer a request to the server processing system to offer for auction a plurality of assets in a group, wherein all assets offered during the auction session are associated with the single seller.

In one form, the winning bidder 235-237 is charged a fee by the administrator of the real time auction system 200 if the winning bid is greater than the set reserve price by seller 225-227.

It will be appreciated, as depicted by the FIG. 2 using dotted lines, that the real time auction system 200 can operate with one or more bidders 235-237 and one or more sellers 225-227 as respective terminal systems 220-222, 230-232.

It will be appreciated that in order for a bidder to participate in an auction session, the bidder preferably is registered with the real time auction system 200 hosted by the server processing system 210. In particular, the bidder is presented with a registration webpage similar to that of the seller described above. Financial details may also be requested in order to ensure that the bidder is capable of submitting a bid during a real time auction. The server processing system, via potential use of a financial transaction processing system 240 or similar, may determine whether sufficient available funds are associated with the bidder such that a bid submitted in an auction using the real time auction system 200 can be effectively covered. Bidder data is stored in the database 211 for use in logging in the bidder into the real time auction system 200.

In another variation, a seller may cancel an auction of an asset which has previously been submitted to the server processing system 210. In an optional form, the seller may be charged an administration fee to remove the asset from being listed for auction. Upon payment of the administration fee, the server processing system 210 removes the associated record in the database 211 relating to the asset accordingly. The server processing system 210 may also adjust one or more records in the database 211 associated with a catalogue which the asset may have been associated as a result of the cancellation.

In another variation, a bidder may require use of a bidder's identifier in order to submit a bid to the auction server 205 in a real time auction. In particular, the bidder's identifier may be a bidder's number which the server processing system issues to the bidder. The server processing system may request financial details to be provided by the bidder. The server processing system may then use the financial transaction processing system to determine whether sufficient funds are available to the bidder via the bidder's terminal. In the event of a successful determination, the server processing system generates, records in memory, and issues a bidder's identifier to the bidder. When the bidder wishes to submit a bid in a real time auction, the bidder's number is input by the bidder using the bidder's terminal and transferred to the auction server 205 of the server processing system. The auction server 205 of the server processing system then compares the received bidder's identifier against records in the memory to determine if the bid is valid. If the comparison is favourable, the bid is considered relevant and is then processed as discussed above. In the event of an unfavourable comparison, the bid is invalid and is ignored by the auction server 205 of the server processing system. The auction server 205 of the server processing system may transfer an error warning to the bidder using an incorrect bidder identifier to indicate the unsuccessful comparison.

In another variation, a seller may transfer data to the server processing system to automatically submit seller input during the auctioning of the seller's asset in the event that the seller may not be able to use the seller terminal system during the auction. In particular, the server processing system is configured to act as an agent for the seller, wherein the server processing system may provide seller input on behalf of the seller to the auction server 205 during the auction of the seller's asset. Specifically, the server processing system may store a record in the database indicative of proxy seller input which the seller has submitted to the server processing system, via the seller terminal, for submission to the auction server 205 during the auction in order to adjust the parameters of the real time auction if required. For example, the seller may set proxy seller input which allows the server processing system to automatically adjust the reserve price for the seller's asset upon a closing warning being issued as discussed above in relation to the server processing system receiving seller's input data. In this instance, when the seller is submitting request data to the server processing system to request the asset to be auctioned, the seller can define an adjustment to the reserve price which may be automatically submitted by the server processing system in the event that the reserve price has not been reached during the auction of the asset.

In another variation, in the event that a seller or a bidder has registered a proxy seller input or a proxy bid respectively with the server processing system, the server processing system may launch a respective computer program in the form of a seller process or a bidder process which is configured to submit bids to the auction server during the auction. The server processing system may launch each process based upon the data stored in the database associated with the proxy bid or seller input. The auction server can transfer data to each process, wherein each process can then determine if input, in the form of a further bid or seller input, is required. Each process can then transfer data to the auction server similarly to a person at a bidder or seller terminal. However, it will be appreciated that in an alternative arrangement the auction server may control the bidding of the proxy bids and seller input.

In another variation, a bidder can record proxy bid settings with the server processing system, which are stored in the database, in order for the processing system to implement a bidding strategy for the particular bidder. In particular, in the event that the particular bidder would like to scare the opposition during the auction and thus avoid resubmitting further bids, the bidder may wish to either submit bids substantially more than the required incremental bid and/or submit a bid relatively quickly within the auction. In this regard, the bidder may set temporal data with the server processing system indicative of the time when a bet can be submitted in the auction. In one form, the temporal data may be indicative of a time period between an accepted bet during the auction of the asset from another bidder and a bid by the respective bidder. For example, the bidder may set the temporal data such that a bid is placed within one second of the proxy process receiving data indicative of a new bid being placed. In another form, the temporal data may be indicative of a time period relative to a closing warning being received from the auction server. For example, the bidder may wish to only place a bet one second after the final call has been reached.

Additionally or alternatively, the particular bidder may set bid increment data indicative of an amount which the bidder wishes to submit. In one form, the bid increment data may be dependent upon the currently accepted bid placed by another bidder up to a maximum bid value limit. For example, the bidder may specify that in the event that a new bid is received between a particular range of values, for example $10 to $20, a new bid be placed which is ten percent higher than the currently accepted bid in an attempt to scare away further bids being placed. In other forms, the bidder may simply nominate a bid increment. The bidder may specify multiple increment bid strategy rules to be applied by the proxy process for particular value ranges of accepted bids placed by other bidders. For example, an additional rule may be set which specifies that in the event that the currently accepted bid is between $20 to $30, a seven percent increase in the currently accepted bid should be placed during the auction. As will be appreciated, the increase in bidding amount should not exceed the maximum amount specified by the bidder. As will be appreciated, the temporal data and the bid increment data set for the proxy process launched for the proxy bidder allows the proxy bidder to apply real-time bidding strategies against real-time bidders who utilise the real-time auction system.

The above embodiments may take the form of an entirely hardware embodiment, an entirely software embodiment, firmware, or an embodiment combining software and hardware aspects.

Many modifications will be apparent to those skilled in the art without departing from the scope of the present invention.

1-65. (canceled)

66. A server processing system for conducting a real time auction, wherein the server processing system is configured to:
receive, from a seller terminal system, request data indicative of a seller's request to auction an asset;
open a real-time auction via an auction portal hosted by the server processing system for auctioning the asset, wherein the server processing system is able to receive and distribute auction activity data in real-time to and from one or more bidder terminal systems;
determine, using the auction activity data, if the auction of the asset has satisfied a close condition of the real-time auction; and
close the real time auction of the asset in response to the close condition being satisfied.

67. The server processing system according to claim 66, wherein the server processing system is configured to:
receive, during the auction and from the seller of the asset, seller input data indicative of the seller adjusting a parameter of an acceptable bid for the asset.

68. The server processing system according to claim 67, wherein the parameter is a reserve price of the asset, wherein the server processing system is configured to adjust in a data store, in response to the seller input data, reserve price data indicative of the reserve price of the asset.

69. The server processing system according to claim 68, wherein the server processing system is configured to adjust in the data store, in response to the seller input data, the reserve price data associated with the asset to be indicative of a current highest bid received for the asset.

70. The server processing system according to claim 68, wherein the server processing system is configured to restrict the seller from adjusting the reserve price until a closing warning is transmitted by the server processing system to the one or more bidder terminals, wherein upon transmission of the closing warning by the server processing system, the server processing system enables the seller to adjust the reserve price of the asset.

71. The server processing system according to claim 70, wherein the server processing system is configured to cancel the closing warning with each of the one or more bidder terminals in response to receiving the seller input data.

72. The server processing system according to claim 68, wherein the server processing system is configured to determine an opening asking bid for the asset, wherein the opening asking bid is calculated based upon a portion of the reserve price for the asset;

73. The server processing system according to claim 72, wherein the portion of the reserve price is weighted according to at least one of:
a number of requests to view an advertisement of the asset prior to the opening of the auction; and
a number of enquiries received regarding the asset prior to the opening of the auction.

74. The server processing system according to claim 66, wherein the server processing system is configured to:
receive, prior to opening the real time auction for the asset, a proxy bid request from one of the bidders;
determine, based upon asset properties of the asset and historical sales data of substantially similar assets, a highest bid value; and
submit, on behalf of the bidder, one or more bids during the real time auction of the asset, wherein the one or more bids fail to exceed the highest bid value.

75. The server processing system according to claim 74, wherein the server processing is configured to store, in a data store, an adjustment to the highest bid value according to data received from the bidder via the respective bidder terminal system.

76. The server processing system, according to claim 66, wherein the server processing system is configured to:
receive a plurality of seller's requests to auction a respective plurality of assets; and
conducting a group of real-time auctions for the plurality of assets, wherein the plurality of real time auctions of the group are conducted in a sequential order.

77. The server processing system according to claim 76, wherein the server processing system is configured to:
determine if a threshold number of seller requests have been received to conduct a group of real time auctions; and
in the event of a successful determination, conduct the group of real time auctions.

78. The server processing system according to claim 76, wherein, the server processing system is configured to, in response to receiving one of the seller's requests:
categorise the respective asset associated with one of the seller requests into one of a plurality of groups of real time auctions;
determine if a threshold number of seller requests have been received for the respective group of real time auctions; and
in the event of a successful determination, conduct the respective group of real time auctions.

79. The server processing system according to claim 78, wherein the server processing system is configured to categorise the asset based upon an asset category, wherein the request data is indicative of the asset category which is defined by the seller at the seller terminal system.

80. The server processing system according to claim 78, wherein the server processing system is configured to conduct a plurality of temporally overlapping groups of real-time auctions, wherein the real time auctions for the assets available in each group are conducted in a sequential order.

81. A bidder terminal system for participating in a real time auction, wherein the bidder terminal system is configured to:
receive and transfer auction activity data in relation to a real time auction via an auction portal hosted by a server processing system for auctioning an asset; and
receive, from the server processing system, closing condition data indicative of a close condition of the real time auction being satisfied, wherein the server processing system determines whether the closing condition is satisfied based upon auction activity data.

82. The bidder terminal system according to claim 81, wherein the bidder terminal system is configured to:
receive, from the server processing system, a closing warning for the auction of the asset;
receive, from the server processing system, a cancellation of the closing warning for the auction of the asset in response to the seller of the asset adjusting, during the auction of the asset, a parameter of an acceptable bid for the asset.

83. The bidder terminal system according to claim 81, wherein the bidder terminal system is configured to transfer, to the server processing system and prior to opening the real time auction for the asset, a proxy bid request from the respective bidder, wherein the server processing system determine, based upon asset properties of the asset and historical sales data of substantially similar assets, a highest bid value, and submits, on behalf of the bidder, one or more bids during the auction of the asset, wherein the one or more bids fail to exceed the highest bid value.

84. The bidder terminal system according to claim 83, wherein the bidder terminal system is configured to:
receive, from the server processing system, data indicative of the highest bid value; and
transfer, to the server processing system, data indicative of an adjustment to the highest bid value indicated by the bidder via the bidder terminal

85. The bidder terminal system according to claim 81, wherein the bidder terminal system is configured to receive, from the server processing system, auction activity data for a group of real-time auctions being conducted for a respective plurality of assets, wherein the plurality of real time auctions are conducted in a sequential order.

86. The bidder terminal system according claim 81, wherein the bidder terminal system is configured to receive auction activity data indicative of a plurality of temporally overlapping groups of real-time auctions being conducted, wherein the real time auctions for the assets available in each group are conducted in a sequential order.
